(19) United States
(12) Patent Application Publication
(10) Pub. No.: US 2018/0196649 A1
(43) Pub. Date: Jul. 12, 2018

(54) WEB APPLICATION ADJUSTMENT FOR DIFFERENT BROWSERS

(71) Applicant: ENT. SERVICES DEVELOPMENT CORPORATION LP, Houston, TX (US)

(72) Inventors: Elad LEVI, Yehud (IL); Avigad MIZRAHI, Yehud (IL); Ran BAR ZIK, Yehud (IL)

(73) Assignee: ENT. SERVICES DEVELOPMENT CORPORATION LP, Houston, TX (US)

(21) Appl. No.: 15/746,391

(22) PCT Filed: Jul. 20, 2015
(86) PCT No.: PCT/US2015/041140

§ 371 Date: Jan. 19, 2018

(51) Int. Cl. G06F 8/41; G06F 11/36

(52) U.S. Cl. CPC G06F 8/447; G06F 11/3612; G06F 11/3668

(57) ABSTRACT

In example implementations, a method and apparatus are provided. The method includes identifying portions of a code for a web application on a first browser that are incompatible with a different browser. The portions of the code that are incompatible are adjusted to include a compatible code for the different browser. A match of the different browser and the first browser is verified when executing the web application with the portions of code that are adjusted to include the compatible code. The adjusted code for the web application for the different browser is generated.

### BACKGROUND

There are many browsers for viewing or consuming web applications. Users consume data from the web via a variety of different devices. Hence, web developers need to support and adjust their pages to this wide range of consumption options.

Currently, developers manually check the differences between the browsers. After detecting a difference, the developer may start implementing changes to the web application manually to make sure that there are no differences between the browsers.

### BRIEF DESCRIPTION OF THE DRAWINGS

FIG. 1 is a block diagram of an example system of the present disclosure;

FIG. 2 is an example difference between web browsers for a web application;

FIG. 3 is a flowchart of a first example of a method for automatically adjusting a code for a web application for different browsers; and

FIG. 4 is a flowchart of a second example of a method for automatically adjusting a web application for different browsers.

### DETAILED DESCRIPTION

The present disclosure discloses a method, system and apparatus for automatically adjusting a web application for different browsers. As discussed above, there are many browsers for viewing or consuming web applications. Users consume data from the web via a variety of different devices. Hence, web developers need to support and adjust their pages to this wide range of consumption options.

Developers may manually check the differences between the browsers. After detecting a difference, the developer may start implementing changes to the web application manually to make sure that there are no differences between the browsers.

In addition, developers may not check for 100% compatibility of a web application with a variety of different browsers before launching the web application. Rather, errors may be found and reported to the developers on the different browsers as users consume the web application. Then the developers address the errors ad hoc. In other words, prior solutions typically do not perform a full analysis of the web application for a variety of different web browsers and versions to ensure 100% full compatibility before launching the web application.

Examples of the present disclosure provide a method for automatically adjusting a web application for different browsers. For example, a developer may develop a web application in a target browser and want to make sure that the web application is compatible with a plurality of additional browsers or versions of a browser. A web application adjustment system may automatically scan the code of the web application to detect unsupported styles or code for the desired additional browsers and adjust the web application to include compatible code.

In addition, the web application adjustment system may execute the web application to identify run-time differences that cannot be detected by simply scanning the code. Again, the web application adjustment system automatically adjusts the code of the web application to ensure that the run-time differences are corrected. The adjusted code for the web application may be provided to the developer for each one of the desired additional browsers. As a result, the web application adjustments are automated to eliminate the inefficiency of web application.

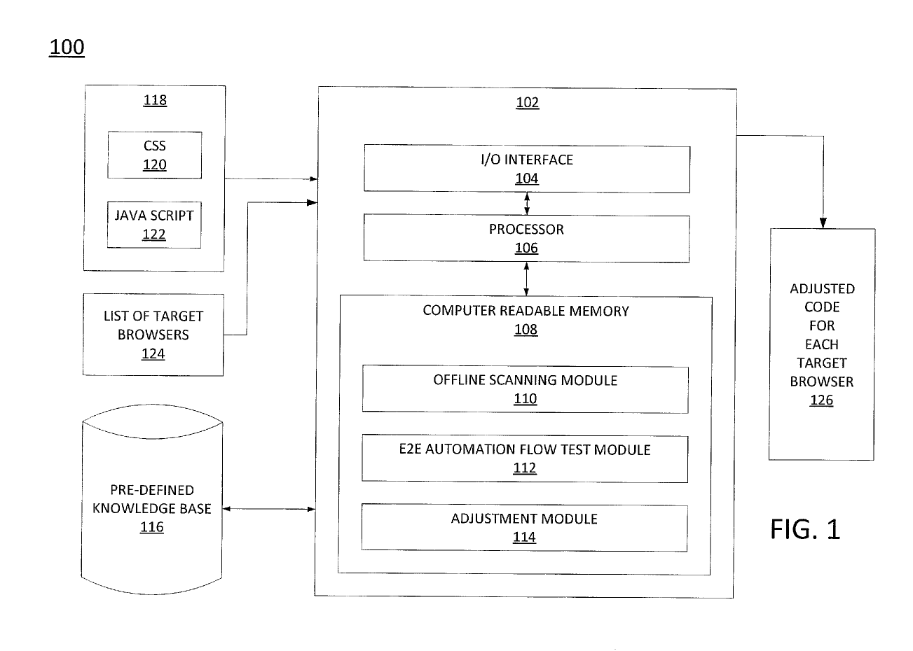

FIG. 1 illustrates an example system 100 of the present disclosure. In one example, the system 100 includes a computer 102 having an input/output (I/O) interface 104, a processor 106 and a non-transitory computer readable memory 108. In one example, the I/O interface 104 may include a user input device (such as a keyboard, a keypad, a mouse, a microphone, and the like), a receiver, a transmitter, a speaker, a display, a speech synthesizer, an output port, an input port, and the like.

In one example, the processor 106 may include multiple hardware processor elements. Furthermore, although only one computer 102 is shown in FIG. 1, the functions described herein may be implemented in a distributed or parallel manner for a particular illustrative example (e.g., using multiple computers 102).

In one example, the non-transitory computer readable memory 108 may include a hard disk drive, a random access memory, and the like. In one example, the non-transitory computer readable memory 108 may include an offline scanning module 110, an end-to-end (E2E) automation flow test module 112, and an adjustment module 114. In one example, the modules 110, 112, and 114 may include instructions that are loaded into the non-transitory computer readable memory 108 and executed by the processor 106.

In one example, the computer 102 may receive computer readable code 118 for a web application. In one example, the code 118 may include cascading style sheet (CSS) files 120 and JavaScript files 122. In one example, the code 118 may be for an anchor browser.

The computer 102 may also receive a list of target browsers 124. In one example, the list of target browsers 124 includes a list of different browsers and browser versions that may execute the code 118 for the web application. For example, the browsers may be Internet web browsers such as Internet Explorer®, Chrome®, Safari®, and the like. The target browsers 124 may also include different versions of the same browser (e.g., Internet Explorer® 8, Internet Explorer® 10, and the like).

As noted above, programmers do not currently test code 118 for a web application for 100% compatibility for all possible browsers that will execute the code 118. Typically, a programmer will debug the code 118 for the anchor browser and then fix bugs as the code 118 is executed on other browsers when error messages are collected.

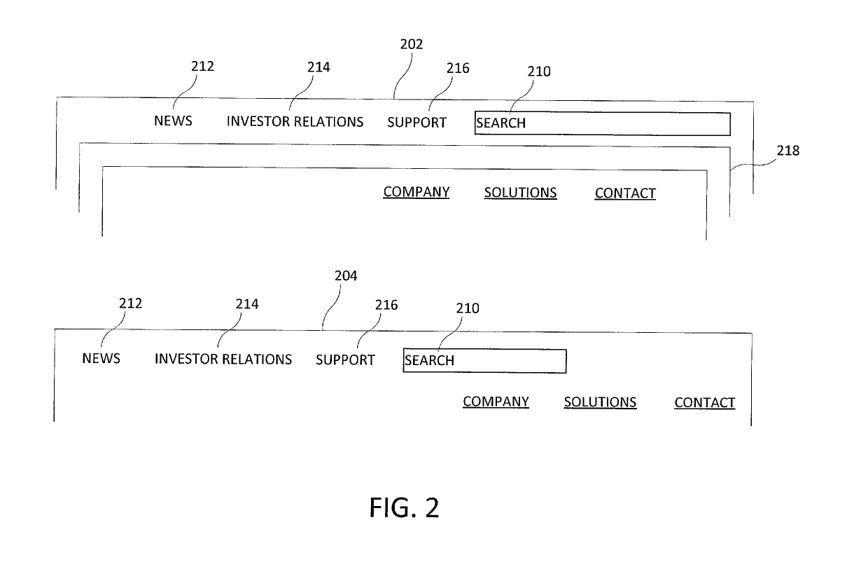

FIG. 2 illustrates an example of the code 118 that is executed on an anchor browser 202 and one of the target browsers 204. The code 118 may be written for the anchor browser 202 and may include various visual details. For example, the code 118 may include links 212, 214, and 216 and a search bar 210 that has a right side alignment. The links 212, 214, and 216 and the search bar 210 may have a particular position, size, opacity, and the like. In addition, the links 212, 214 and 216 may have a particular sized font. The code 118 may also use a square border 218.

However, when the code 118 is executed on the target browser 204, the target browser 204 may shift the links 212, 214, and 216 and the search bar 210 to a left alignment. In other words, the links 212, 214, and 216 and the search bar 210 may have a different position, size, opacity, and the like in the target browser 204. The font for the links 212, 214, and 216 may be a different size (e.g., smaller). In addition, the code 118 used to create the border 218 may not be recognized, i.e., not shown, in the target browser 204.

One example of the present disclosure automatically identifies differences in the list of target browsers 124 and the anchor browser when executing the code 118. The code 118 may be debugged and corrected for 100% compatibility with each one of the target browsers in the list of target browsers 124 before the code 118 for the web application is launched.

In one example, the code 118 and the list of target browsers 124 are provided to the computer 102 and the computer 102 may generate an adjusted code 126 for each target browser. In one example, the computer 102 may use the offline scanning module 110 to identify differences in the code 118. In other words, the offline scanning module 110 may be used for scanning the code 118 for the web application on the anchor browser to identify portions of the code that are unsupported portions in each one of the list of target browsers 124.

The computer 102 may use the E2E automation module 112 to execute a test flow of the code 118 to identify differences in run-time. For example, the E2E automation module 112 may execute a test flow of the code 118 of the web application on each one of the list of target browsers 124 to identify additional portions of the code that cause a run-time difference between the anchor browser and each one of the list of target browsers 124. In other words, some portions of the code 118 may appear to be the same in the anchor browser and the target browser. However, when the code 118 is executed the anchor browser and the target browser may have differences at run-time that may be undetectable by only looking at the code 118.

The adjustment module 114 may then adjust the portions of the code 118 that cause differences between the anchor browser and the target browser. By adjusting the code, the code 118 will be visually similar and respond in a similar way when executed at run time in the anchor browser and the target browser. Said another way, the adjustment module 114 may be used to adjust portions of the code 118 that are unsupported by the list of target browsers 124 with compatible code and adjust the additional portions of the code 118 to correct run-time differences for each one of the list of target browsers 124.

In one example, a predefined knowledge base 116 (also referred to herein as a predefined knowledge base of adjustments) may be used to obtain compatible code that is used to make adjustments to the code 118. In one example, the predefined knowledge base 116 may be pre-populated with compatible code that is known in advance to adjust the code 118 for a variety of different target browsers. However, as new browsers are created or new versions of the same browser are created, additional compatible codes may be added to the predefined knowledge base 116 over time. In other words, the predefined knowledge base of adjustments 116 may be continuously updated over time with new compatible codes that are created.

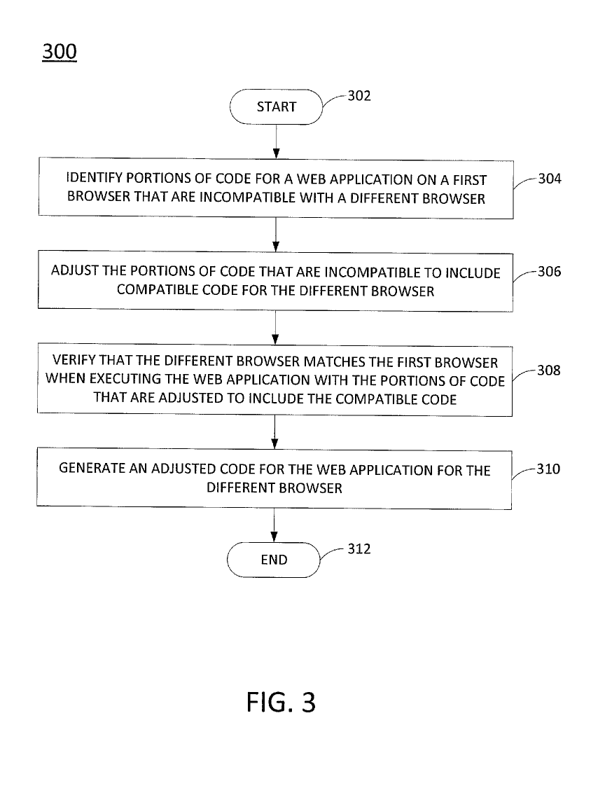

FIG. 3 illustrates an example flowchart of a method 300 for automatically adjusting a code for a web application for different browsers. In one example, the method 300 may be performed by the computer 102.

At block 302 the method 300 begins. At block 304, the method 300 identifies portions of code for a web application on a first browser that are incompatible with a different browser. For example, the code may be written for the anchor browser. The code may be debugged to be error free and 100% compatible with the anchor browser. However, the programmer may want the code to be compatible with a different browser or a plurality of different browsers (e.g., types of browsers or different versions of the same browser).

In one example, a computer may receive a code for the web application that includes CSS files and JavaScript files. The computer may also receive a target browser or a list of target browsers that may also execute the code. In one example, the scanning may include scanning the code and performing a run time analysis of the code (e.g., executing a test flow of the code on each one of the different browsers) to identify the incompatible portions of code. An offline scanning module may scan the CSS files of the code to identify portions of the code that are incompatible with the different browser or each one of the plurality of different browsers. The offline scanning module may also scan the JavaScript files of the code to identify unsupported objects within the JavaScript files. An E2E automation flow test module may perform the run-time analysis to identify run-time differences created when the code is executed on the different browser or different browsers.

At block 306, the method 300 adjusts the portions of code that are incompatible to include compatible code for the different browser. For example, unsupported styles in the CSS files may be adjusted with a corresponding style in the different browser or each one of the plurality of different browsers. Unsupported objects within the JavaScript file may be adjusted with a corresponding object in the different browser or each one of the plurality of different browsers. The portions of the code that create run-time differences may be adjusted to correct the run-time differences.

In one example, a predefined knowledge base may be used to store various compatible codes that are used to make the adjustments. The predefined knowledge base of adjustments may be searched for compatible code. If the compatible code is not found in the predefined knowledge base of adjustments, then a new compatible code may be created. The predefined knowledge base of adjustments may be updated with the new compatible code that is created. In one example, an adjustment module may make the adjustments to the code.

At block 308, the method 300 verifies that the different browser matches the first browser when executing the web application with the portions of code that are adjusted to include the compatible code. For example, the adjusted code for the web application on each target browser may be executed to determine if any differences still exist. If any differences still exist, the identifying and the adjusting blocks 304 and 306 may be repeated until no differences exist between the anchor browser and each one of the target browsers when executing the adjusted code for the web application.

At block 310, the method 300 generates an adjusted code for the web application for the different browser. For example, after the code is adjusted and a verification is performed confirming that no differences exist between the anchor browser and the target browser, the adjusted code may be generated and outputted for implementation in the different browser or the plurality of different browsers. At block 312, the method 300 ends.

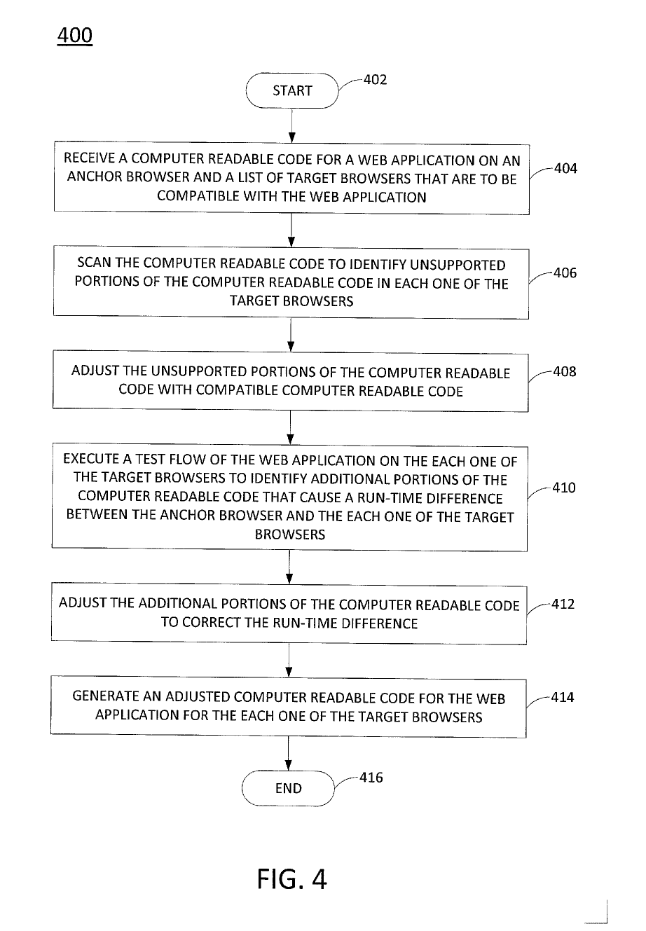

FIG. 4 illustrates an example flowchart of another method 400 for automatically adjusting a code for a web application for different browsers. In one example, the method 400 may be performed by the computer 102.

At block 402 the method 400 begins. At block 404, the method 400 receives a computer readable code for a web application on an anchor browser and a list of target browsers that are to be compatible with the web application. In one example, the computer readable code may include CSS files and JavaScript files.

At block 406, the method 400 scans the computer readable code to identify unsupported portions of the computer readable code in each one of the target browsers. For example, an offline scanning module may scan the computer readable code and detect portions of the code (e.g., without executing the code) that are unsupported in each one of the target browsers.

For example, the unsupported portions of the computer readable code may be an unsupported style within the CSS file. To illustrate, the use of a gradient style may only be supported in the anchor browser and incompatible with a target browser. In another example, unsupported portions of the computer readable code may include unsupported objects within the JavaScript file. To illustrate, a JavaScript console object (e.g., console.log) in the anchor browser may cause exceptions in certain versions of a target browser.

At block 408, the method 400 adjusts the unsupported portions of the computer readable code with compatible computer readable code. In one example, a predefined knowledge base of adjustments may be searched to find the compatible code to make the adjustments to the computer readable code.

Using the above examples, the anchor browser may have a gradient style that has the following code:

-webkit-gradient (linear, right top, left bottom, from (#0c93c0), to (#FFF));
As noted above, the gradient style may be unsupported with a target browser. As a result, the predefined knowledge base of adjustments may be searched to find the following compatible code for the gradient in the target browser:

-ms-filter:
“progid:DXImageTransform.Microsoft.Gradient(startColorStr=’#0c93c0’,
endColorStr=’#FFFFFF’, GradientType=0)”;

Also as noted above, the anchor browser may use a JavaScript console object (e.g., console.log) that causes an exception in certain versions of the target browser. As a result, the predefined knowledge base of adjustments may be searched to find the following compatible code for the JavaScript console object:

If (typeof console==“undefined”) {this.console={log: function( ){ }};}

In one example, when adjustments are made to the computer readable code for a particular one of the target browsers, a unique identification number may be assigned to the adjustment. As a result, the adjustment made for the particular portion of the computer readable code will not affect other portions of the computer readable code.

At block 410, the method 400 executes a test flow of the web application on the each one of the target browsers to identify additional portions of the computer readable code that cause a run-time difference between the anchor browser and the each one of the target browsers. For example, some differences between the anchor browser and the target browser cannot be identified by looking at the code itself. In other words, some differences are more easily identified when executing the code of the web application on each one of the target browsers.

In one example, a headless browser may be used to execute a test flow of the computer readable code of the web application on the anchor browser and each one of the target browsers. In one example, the test flow may analyze the web application state document object model (DOM) structure and map each element with its CSS selector as a unique identification and its style together with appearance information (e.g., a position). Said another way, a DOM structure of the web application on the anchor browser may be compared with a DOM structure of the web application on each one of the target browsers to verify that a response at each node within the DOM structure of the web application on the anchor browser and each corresponding node within the DOM structure of the web application on the each one of the target browsers is identical.

To illustrate, by analyzing a position of the elements in a DOM, the run time analysis may recognize that while in the anchor browser the upper menu (e.g., links 212, 214 and 216 and the search bar 210) is shifted to the right, the target browser menu is shifted to the left. Notably, without a test flow being executed, the computer readable code by itself would not reveal this difference in the upper menu.

At block 412, the method 400 adjusts the additional portions of the computer readable code to correct the run-time differences. For example, the predefined knowledge base of adjustments may be searched to find the compatible code to correct the run-time differences.

Using the above example, the run-time difference in the upper menu may be caused by a float style of the anchor browser having the following code:

.main-menu-selector {float: right;}
The predefined knowledge base of adjustments may be searched to find the compatible code to adjust the above additional portion of code causing the run-time differences. The compatible code may be as follows:

.main-menu-selector: after {

content: “.”;
display: block;
height: 0;
visibility: hidden;
clear: both:

}

The code that is adjusted with the compatible code above allows the target browser to display the upper menu to appear in the same location and position as the anchor browser.

In one example, the blocks 406, 408, 410 and 412 may be repeated until no differences exist between the anchor browser and each one of the target browsers when executing the computer readable code of the web application. In other words, the adjustments may be verified to determine if the adjustments corrected any differences. If differences still exist between the anchor browser and any one of the target browsers the scanning block 406, the adjustment block 408, the executing the test flow block 410 and the adjustment block 412 may be repeated until no differences exist.

At block 414, the method 400 may generate an adjusted computer readable code for the web application for the each one of the target browsers. For example, when the adjustments are verified to correct all of the differences between the anchor browser and each one of the target browsers, the adjusted computer readable code may be generated. The adjusted computer readable code that is generated may then be outputted for implementation. At block 416, the method 400 ends.

It should be noted that although not explicitly specified, any of the blocks, functions, or operations of the example methods 300 and 400 described above may include a storing, displaying, and/or outputting block as required for a particular application. In other words, any data, records, fields, and/or intermediate results discussed in the methods can be stored, displayed, and/or outputted to another device as required for a particular application. Furthermore, blocks, functions, or operations in FIGS. 3 and 4 that recite a determining operation, or involve a decision, do not necessarily require that both branches of the determining operation be practiced.

It will be appreciated that variants of the above-disclosed and other features and functions, or alternatives thereof, may be combined into many other different systems or applications. Various presently unforeseen or unanticipated alternatives, modifications, or variations, therein may be subsequently made which are also intended to be encompassed by the following claims.

1. A method comprising:
identifying, by a processor, portions of a code for a web application on a first browser that are incompatible with a different browser;
adjusting, by the processor, the portions of the code that are incompatible to include compatible code for the different browser;
verifying, by the processor, that the different browser matches the first browser when executing the web application with the portions of the code that are adjusted to include the compatible code; and
generating, by the processor, an adjusted code for the web application for the different browser.

2. The method of claim 1, wherein the identifying and the adjusting further comprise:
scanning, by the processor, a cascading style sheet (CSS) file to identify unsupported styles within the CSS file; and
adjusting, by the processor, the unsupported styles within the CSS file with a corresponding style in the different browser.

3. The method of claim 1, wherein the identifying and the adjusting further comprise:
scanning, by the processor, a JavaScript file to identify unsupported objects within the JavaScript file; and
adjusting, by the processor, the unsupported objects within the JavaScript file with a corresponding object in the different browser.

4. The method of claim 1, wherein the identifying and the adjusting further comprise:
executing, by the processor, a test flow of the web application on the different browser to identify the portions of the code that cause a run-time difference between the first browser and the different browser; and
adjusting, by the processor, the portions of the code to correct the run-time difference.

5. The method of claim 1, the adjusting further comprising:
searching, by the processor, a pre-defined knowledge base of adjustments for the compatible code;
if the compatible code is not found in the pre-defined knowledge base of adjustments, then creating, by the processor, a new compatible code; and
updating, by the processor, the pre-defined knowledge base of adjustments with the new compatible code that is created.

6. An apparatus comprising:
an input and output interface;
a processor; and
a computer readable memory, the computer readable memory comprising modules that are controlled by the processor, the modules comprising:
an offline scanning module for scanning a code for a web application on a first browser to identify portions of the code that are unsupported portions in each one of a plurality of different browsers;
an end-to-end automation flow test module for executing a test flow of the web application on the each one of the plurality of different target browsers to identify additional portions of the code that cause a run-time difference between the first browser and the each one of the plurality of different browsers; and
an adjustment module to adjust the portions of the code that are unsupported with a compatible code and the additional portions of the code to correct the run-time difference for the each one of the plurality of different browsers.

7. The apparatus of claim 6, further comprising:
a pre-defined knowledge base of adjustments.

8. The apparatus of claim 6, wherein the code comprises a cascading style sheet (CSS) file and a JavaScript file that are received via the input and output interface.

9. A method comprising:
receiving, by a processor, a computer readable code for a web application on an anchor browser and a list of target browsers that are to be compatible with the web application;
scanning, by the processor, the computer readable code to identify unsupported portions of the computer readable code in each one of the target browsers;
adjusting, by the processor, the unsupported portions of the computer readable code with a compatible computer readable code for the each one of the target browsers;
executing, by the processor, a test flow of the web application on the each one of the target browsers to identify additional portions of the computer readable code that cause a run-time difference between the anchor browser and the each one of the target browsers;
adjusting, by the processor, the additional portions of the computer readable code to correct the run-time difference; and
generating, by the processor, an adjusted computer readable code for the web application for the each one of the target browsers.

10. The method of claim 9, wherein the computer readable code comprises a cascading style sheet (CSS) file and a JavaScript file.

11. The method of claim 10, wherein the unsupported portions of the computer readable code comprise an unsupported style within the CSS file and the adjusting the unsupported portions comprises replacing the unsupported style with a corresponding style in the each one of the target browsers.

12. The method of claim 10, wherein the unsupported portions of the computer readable code comprise an unsupported object within the JavaScript file and the adjusting the unsupported portions comprises replacing the unsupported object with a corresponding object in the each one of the target browsers.

13. The method of claim 9, wherein the list of target browsers comprises different versions of the target browsers.

14. The method of claim 9, wherein the executing the test flow of the web application on the each one of the target browsers further comprises:
comparing, by the processor, a document object model (DOM) structure of the web application on the anchor browser with a DOM structure of the web application on each one of the target browsers to verify that a response at each node within the DOM structure of the web application on the anchor browser and each corresponding node within the DOM structure of the web application on the each one of the target browsers is identical.

15. The method of claim 9, wherein the adjusting the unsupported portions and the adjusting the additional portions use a pre-defined knowledge base of adjustments.
